(19) United States
(12) Patent Application Publication
(10) Pub. No.: US 2026/0349503 A1
(43) Pub. Date: Nov. 5, 2026

(54) CONSTRUCTION METHOD AND APPARATUS FOR GAZE PREDICTION MODEL, DEVICE, AND STORAGE MEDIUM

(71) Applicant: Beijing Zitiao Network Technology Co., Ltd., Beijing (CN)

(72) Inventor: Liangliang WANG, Beijing (CN)

(21) Appl. No.: 19/487,441

(22) PCT Filed: May 29, 2024
(86) PCT No.: PCT/CN2024/095931

§ 371 Date: Nov. 24, 2025

(30) Foreign Application Priority Data
May 29, 2023 (CN) 202310620447.8

(51) Int. Cl. G06F 3/01; G06N 3/084; G06N 3/09; G06V 20/70; G06V 40/18

(52) U.S. Cl. CPC G06F 3/013; G06N 3/084; G06N 3/09; G06V 20/70; G06V 40/193

(57) ABSTRACT

A construction method for a gaze prediction model includes: inputting a plurality of eye sample images into a constructed teacher model and a student model to be constructed, to obtain reference gaze information and predicted gaze information, respectively; and if it is determined, based on the predicted gaze information and corresponding target gaze labels, that a loss of the student model to be constructed does not satisfy a convergence condition, updating a model parameter of the student model to be constructed, or otherwise, determining the student model to be constructed as the gaze prediction model. When losses determined based on the predicted gaze information and corresponding truth gaze labels satisfy a label filter condition, target gaze labels of the eye sample images include corresponding reference gaze information, or otherwise, the target gaze labels of the eye sample images include the corresponding truth gaze labels.

### CROSS-REFERENCE TO RELATED APPLICATIONS

The present application is based on and claims priority to Chinese Application No. 202310620447.8, filed on May 29, 2023, and entitled “CONSTRUCTION METHOD AND APPARATUS FOR GAZE PREDICTION MODEL, DEVICE, AND STORAGE MEDIUM”, the disclosure of which is incorporated herein by reference in its entirety.

### TECHNICAL FIELD

The present disclosure relates to the field of computer vision technologies, and in particular, to a construction method and apparatus for a gaze prediction model, a device, and a storage medium.

### BACKGROUND

A gaze prediction technology is a technology of outputting a gaze direction based on a given eye image by using a network structure. The gaze prediction technology is widely used in the fields of human-computer interaction, virtual reality, augmented reality, medical analysis, etc.

### SUMMARY

According to an aspect of the present disclosure, there is provided a construction method for a gaze prediction model. The method includes:
inputting a plurality of eye sample images into a constructed teacher model to obtain a plurality of pieces of reference gaze information;
inputting the plurality of eye sample images into a student model to be constructed to obtain a plurality of pieces of predicted gaze information, where each eye sample image, each piece of reference gaze information, and each piece of predicted gaze information correspond to each other;
when losses determined based on the predicted gaze information and corresponding truth gaze labels satisfy a label filter condition, determining that target gaze labels of the eye sample images include corresponding reference gaze information, or if the losses determined based on the predicted gaze information and the corresponding truth gaze labels do not satisfy the label filter condition, determining that the target gaze labels of the eye sample images include the corresponding truth gaze labels; and
if it is determined, based on the plurality of pieces of predicted gaze information and corresponding target gaze labels, that a loss of the student model to be constructed does not satisfy a convergence condition, updating a model parameter of the student model to be constructed based on the plurality of pieces of predicted gaze information and the corresponding target gaze labels, or if it is determined, based on the plurality of pieces of predicted gaze information and the corresponding target gaze labels, that the loss of the student model to be constructed satisfies the convergence condition, determining the student model to be constructed as the gaze prediction model.

According to another aspect of the present disclosure, there is provided a gaze prediction method. The method includes:
obtaining an eye image; and
inputting the eye image into a gaze prediction model to obtain gaze information, where the gaze prediction model is constructed by the construction method for a gaze prediction model according to an exemplary embodiment of the present disclosure.

According to another aspect of the present disclosure, there is provided a construction apparatus. The apparatus includes:
a prediction module configured to input a plurality of eye sample images into a constructed teacher model to obtain a plurality of pieces of reference gaze information; and
a construction module configured to: input the plurality of eye sample images into a student model to be constructed to obtain a plurality of pieces of predicted gaze information, where each eye sample image, each piece of reference gaze information, and each piece of predicted gaze information correspond to each other; and if it is determined, based on the plurality of pieces of predicted gaze information and corresponding target gaze labels, that a loss of the student model to be constructed does not satisfy a convergence condition, update a model parameter of the student model to be constructed based on the plurality of pieces of predicted gaze information and the corresponding target gaze labels; or if it is determined, based on the plurality of pieces of predicted gaze information and the corresponding target gaze labels, that the loss of the student model to be constructed does not satisfy the convergence condition, determine the student model to be constructed as a gaze prediction model.

When losses determined based on the predicted gaze information and corresponding truth gaze labels satisfy a label filter condition, target gaze labels of the eye sample images are corresponding reference gaze information.

According to another aspect of the present disclosure, there is provided a gaze prediction apparatus. The apparatus includes:
an obtaining module configured to obtain an eye image; and
a prediction module configured to input the eye image into a gaze prediction model to obtain gaze information, where the gaze prediction model is constructed by the construction method for a gaze prediction model according to an exemplary embodiment of the present disclosure.

According to another aspect of the present disclosure, there is provided an electronic device. The electronic device includes:
a processor; and
a memory storing a program,
where the program includes instructions that, when executed by the processor, cause the processor to perform the methods according to exemplary embodiments of the present disclosure.

According to another aspect of the present disclosure, there is provided a non-transitory computer-readable storage medium storing computer instructions. The computer instructions are used to cause a computer to perform the methods according to exemplary embodiments of the present disclosure.

### BRIEF DESCRIPTION OF THE DRAWINGS

Further details, features and advantages of the present disclosure are disclosed in the following description of exemplary embodiments in conjunction with the accompanying drawings, in which:

FIG. 1 is a flowchart of a construction method for a gaze prediction model according to an exemplary embodiment of the present disclosure;

FIG. 2 is a flowchart of a gaze prediction method according to an exemplary embodiment of the present disclosure;

FIG. 3 is a schematic block diagram of functional modules of a construction apparatus according to an exemplary embodiment of the present disclosure;

FIG. 4 is a schematic block diagram of functional modules of a gaze prediction apparatus according to an exemplary embodiment of the present disclosure;

FIG. 5 is a schematic block diagram of a chip according to an exemplary embodiment of the present disclosure; and

FIG. 6 is a structural block diagram of an exemplary electronic device that can be used to implement an embodiment of the present disclosure.

### DETAILED DESCRIPTION

Embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include” and variants thereof used herein indicate an open-ended inclusion, that is, “include but are not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below. It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

Before the embodiments of the present disclosure are described, the following definitions are provided for relevant terms involved in the embodiments of the present disclosure.

A virtual reality (VR) technology, also referred to as a virtual actualization or immersive technology, is a new practical technology developed in the 20^{th} century. The virtual reality technology encompasses computer, electronic information, and simulation technologies. Its basic implementation mainly relies on the computer technology, and utilizes and integrates the latest development achievements of various advanced technologies, such as a three-dimensional graphics technology, a multimedia technology, the simulation technology, a display technology, and a servo technology, to create, via a device such as a computer, a realistic virtual world that provides multi-sensory experience including a three-dimensional visual sense, a tactile sense, an olfactory sense, etc., thereby making people in the virtual world feel immersive.

Knowledge distillation (KD) is a construction method based on a “teacher-student network theory”. As the name implies, knowledge distillation is to distill and extract knowledge contained in a constructed teacher model to a student model. Knowledge transfer is implemented by introducing a soft-target correlated with the teacher model as a part of a total loss to induce construction of the student model.

A loss function, also referred to as an objective function, is an important equation for measuring a difference between a predicted value and a target value. A larger output value (loss) of the loss function indicates a greater difference. Therefore, construction of a deep neural network becomes a process of minimizing this loss.

A model parameter is an optimal parameter obtained by using construction samples in model construction, and may be understood as an “internal parameter” of a model.

When a user uses a VR device, the VR device may acquire an eye image of the user by using a gaze tracking system, and predict a gaze of the user based on the eye image of the user. Then, the VR device is controlled to perform gaze tracking based on the predicted gaze of the user, to improve the user's comfort.

A gaze prediction technology is a technology of outputting a gaze direction based on a given eye image by using a network structure. The gaze prediction technology is widely used in the fields of human-computer interaction, virtual reality, augmented reality, medical analysis, etc. In applications, a subject is guided to gaze at a different point, and an eye image is acquired at this time, to obtain one piece of data. In addition, each point corresponds to one known gaze direction, so that the gaze direction may be used as a label of data. However, in actual operations, there is often a situation where, for example, the subject is guided to gaze at a point x, but does not actually gaze at this point accurately. As a result, there is a large amount of dirty data in data for gaze estimation, greatly affecting model accuracy.

Specifically, in the related art, the eye image of the user may be input into a gaze prediction model to obtain the gaze of the user. When the gaze prediction model is constructed, a large number of gaze-labeled eye sample images may be used as a dataset, to construct the gaze prediction model. When the gaze-labeled eye sample image is acquired, the subject may be guided to gaze at a preset gaze point, but the subject may not follow the guidance to gaze at the preset gaze point for some reasons, resulting in a mismatch between the acquired eye sample image and a corresponding gaze label. Based on this, there is a certain amount of dirty data in the dataset for constructing the gaze prediction model, and the dirty data may be represented as a mismatch between an eye sample image and a corresponding truth gaze label, resulting in low prediction accuracy of the constructed gaze prediction model.

In view of the above-mentioned problems, exemplary embodiments of the present disclosure provide a construction method for a gaze prediction model and a gaze prediction method, in which a gaze label corresponding to an eye sample image used by a student model may be cleaned based on a knowledge distillation theory by using reference gaze information output by a teacher model, to reduce the impact of dirty data on the construction of the gaze prediction model and improve the prediction accuracy of the gaze prediction model. It should be understood that relevant eye images involved in the construction method for a gaze prediction model and the gaze prediction method provided in the exemplary embodiments of the present disclosure may be images including human eyes or images including animal eyes. This is not limited herein.

In one or more technical solutions provided in the exemplary embodiments of the present disclosure, during the construction of the gaze prediction model, a plurality of eye sample images are input into a student model to be constructed to obtain a plurality of pieces of predicted gaze information, and then a loss of the student model to be constructed is determined based on the plurality of pieces of predicted gaze information and corresponding target gaze labels. If the loss satisfies a convergence condition, it indicates that a model parameter of the student model to be constructed is accurate, and the student model to be constructed can accurately predict predicted gaze information of an eye sample image. If the loss does not satisfy the convergence condition, it indicates that the model parameter of the student model to be constructed is not so accurate, and the student model to be constructed cannot accurately predict predicted gaze information of an eye sample image. Therefore, the model parameter of the student model to be constructed may be updated based on the plurality of pieces of predicted gaze information and the corresponding target gaze labels, to ensure the accuracy of the model parameter of the student model to be constructed.

Moreover, in the exemplary embodiments of the present disclosure, in determining the loss of the student model to be constructed, when a loss determined based on a piece of predicted gaze information and a corresponding truth gaze label satisfies a label filter condition, it indicates that there is a great difference between the predicted gaze information and the corresponding truth gaze label. There may be two reasons for this difference. For one thing, there may be a problem with the model parameter of the student model to be constructed. For the other thing, there may be a poor match between the truth gaze label and a corresponding eye sample image, that is, the truth gaze label and the corresponding eye sample image are essentially dirty data in construction samples. Based on this, corresponding reference gaze information output by the constructed teacher model based on the eye sample image may be determined as a target gaze label of the eye sample image. In this way, interference caused by the poor match between the truth gaze label and the corresponding eye sample image is reduced. Therefore, the accuracy of the determined loss of the student model to be constructed is improved, and high accuracy of the finally obtained gaze prediction model is ensured.

The methods in the exemplary embodiments of the present disclosure may be performed by an electronic device or a chip applied to the electronic device. The electronic device may be an electronic device with a display function, for example: a mobile phone, a tablet computer, a wearable device, a vehicle-mounted device, a laptop, an ultra-mobile personal computer (UMPC), a netbook, a palmtop (personal digital assistant, PDA), and a wearable device based on augmented reality (AR) and/or virtual reality (VR) technologies.

For example, when the electronic device is a wearable device, the wearable device may also be a general term of wearable devices that are intelligently designed and developed for daily wear using a wearable technology, for example, glasses, gloves, watches, clothes, and shoes. The wearable device is a portable device that can be directly worn on a body or integrated into clothes or an accessory of the user. The wearable device is not only a hardware device, but also implements a powerful function through software support, data exchange, and cloud interaction. In a broad sense, the wearable smart device may be a full-featured and large-size device that can implement some or all of functions without relying on a smartphone, for example a smartwatch or smart glasses, and a device that focuses only on a specific type of application function and needs to be used together with another device such as a smartphone, for example, various types of smart bands and smart jewelry for monitoring physical signs.

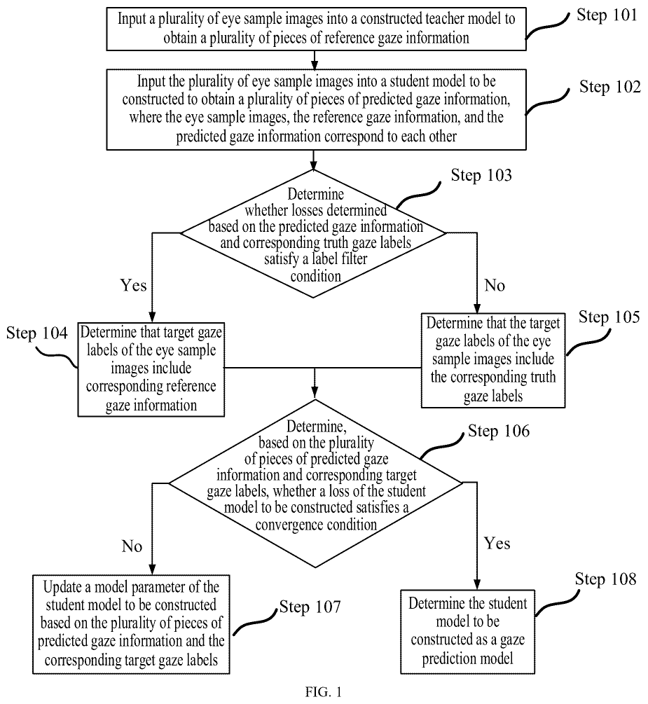

FIG. 1 is a flowchart of a construction method for a gaze prediction model according to an exemplary embodiment of the present disclosure. As shown in FIG. 1, the construction method for a gaze prediction model in the exemplary embodiment of the present disclosure includes the following steps.

Step 101: Input a plurality of eye sample images into a constructed teacher model to obtain a plurality of pieces of reference gaze information. The eye sample images may be eye sample images acquired by an image acquisition apparatus. The eye sample images may be eye pictures or eye videos.

In actual applications, the eye sample images may be acquired by a camera in a VR device, and then the plurality of acquired eye sample images are input into the constructed teacher model for training. The teacher model may be any existing open-source neural network model for gaze prediction. This is not limited herein. For example, the teacher model may be a visual geometry group (VGG) network, a deep residual network (ResNet), or a convolutional neural network (CNN).

A construction process of the teacher model may be: inputting a plurality of gaze-labeled eye sample images into a teacher model to obtain a plurality of pieces of corresponding reference gaze information, and calculating a loss based on the reference gaze information and truth gaze labels corresponding to the plurality of eye sample images. If the loss satisfies an iteration condition, it indicates that the reference gaze information of the eye sample images from the teacher model is inaccurate, and a model parameter of the teacher model may be updated based on the reference gaze information and the truth gaze labels corresponding to the plurality of eye sample images (the model parameter may include a weight and an offset). If the loss satisfies an iteration termination condition, it indicates that the reference gaze information of the eye sample images predicted by the teacher model is relatively accurate, and the constructed teacher model can be obtained.

The truth gaze label carried in the eye sample image should be as accurate as possible, to improve the accuracy of the teacher model. The eye sample images for constructing the teacher model may be the same as or different from eye sample images input into the teacher model for constructing a student model. This is not limited herein.

Step 102: Input the plurality of eye sample images into a student model to be constructed to obtain a plurality of pieces of predicted gaze information, where the eye sample images, the reference gaze information, and the predicted gaze information correspond to each other. For the descriptions of the plurality of eye sample images input into the student model to be constructed, reference may be made to the related descriptions provided above, and details are not described herein.

In this exemplary embodiment of the present disclosure, the plurality of eye sample images input into the student model to be constructed may be the same as the plurality of eye sample images input into the constructed teacher model. For example, when the eye sample images, the reference gaze information, and the predicted gaze information correspond to each other, if the same eye sample image is input into the constructed teacher model and the student model to be constructed, the same eye sample image may correspond to reference gaze information output by the constructed teacher model and predicted gaze information output by the student model to be constructed, and there is also a correspondence between the reference gaze information and the predicted gaze information.

Considering that there may be a certain amount of dirty data when the eye sample images used carry truth gaze labels, in this exemplary embodiment of the present disclosure, the truth gaze labels may be further cleaned, to highly match the truth gaze labels corresponding to the eye sample images used in loss calculation with the eye sample images, thereby improving the accuracy of the student model to be constructed. Based on this, the method in this exemplary embodiment of the present disclosure may further include the following steps.

Step 103: Determine whether losses determined based on the predicted gaze information and corresponding truth gaze labels satisfy a label filter condition. Here, the truth gaze labels carried in the eye sample images corresponding to the predicted gaze information may be the truth gaze labels corresponding to the predicted gaze information. For any eye sample image, a loss may be determined based on predicted gaze information and a corresponding truth gaze label.

For any eye sample image, the loss may be considered a single sample loss. If the single sample loss satisfies the label filter condition, there is a great difference between the eye sample image and the truth gaze label corresponding to the eye sample image used in loss calculation. There may be two reasons for this difference. For one thing, there may be a problem with a model parameter of the student model to be constructed. For the other thing, there may be a poor match between the truth gaze label and the corresponding eye sample image, that is, the truth gaze label and the corresponding eye sample image are essentially dirty data in constructions samples, and the predicted gaze information and the corresponding truth gaze label cannot be directly used for confirmation of convergence of the student model to be constructed. In this case, step 104 may be performed. When the loss determined based on the predicted gaze information and the corresponding truth gaze label does not satisfy the label filter condition, it indicates that the truth gaze label corresponding to the eye sample image used in loss calculation is matched well with the eye sample image, and the predicted gaze information and the corresponding truth gaze label can be directly used for confirmation of the convergence of the student model to be constructed. In this case, step 105 may be performed.

Step 104: Determine that target gaze labels of the eye sample images include corresponding reference gaze information. Here, since the same eye sample image is separately input into the student model to be constructed and the constructed teacher model, and the constructed teacher model has relatively high gaze prediction accuracy, when the loss determined based on the predicted gaze information and the corresponding truth gaze label satisfies the label filter condition, the truth gaze label carried in the eye sample image may be replaced with the reference gaze information corresponding to the eye sample image, and the reference gaze information corresponding to the eye sample image may be used as the target gaze label for determining the convergence of the student model to be constructed. In this way, the convergence accuracy of the student model to be constructed is improved.

It can be seen that in this exemplary embodiment of the present disclosure, when the loss determined based on the predicted gaze information and the corresponding truth gaze label satisfies the label filter condition, interference caused by the poor match between the truth gaze label and the corresponding eye sample image to construction can be reduced.

Step 105: Determine that the target gaze labels of the eye sample images include the corresponding truth gaze labels. In this case, the loss determined based on the predicted gaze information and the corresponding truth gaze label does not satisfy the label filter condition, so that there is no need to clean the truth gaze label. Therefore, it may be determined that the target gaze label of the eye sample image is the corresponding truth gaze label.

Step 106: Determine, based on the plurality of pieces of predicted gaze information and corresponding target gaze labels, whether a loss of the student model to be constructed satisfies a convergence condition. Here, an architecture of the student model may be a lightweight model architecture, such as a SqueezeNet, a MobileNet, or a ShuffleNet.

In actual applications, in determining the loss of the student model to be constructed based on the plurality of pieces of predicted gaze information and the corresponding target gaze labels, the plurality of pieces of predicted gaze information and the corresponding target gaze labels may be substituted into a loss function, to determine the loss of the student model to be constructed. The loss function may be a softmax loss function, or another possible loss function, such as a cross-entropy loss.

The convergence condition here may be that the loss of the student model to be constructed is less than or equal to a preset loss, or that the loss of the student model to be constructed is stable, that is, the loss of the student model to be constructed remains constant or fluctuates within a range in different iteration processes.

When the loss of the student model to be constructed does not satisfy the convergence condition, it indicates that there is a great difference between the predicted gaze information output by the student model and the target gaze label, and a gaze prediction requirement in an inference phase cannot be met (for example, the gaze prediction accuracy does not meet a requirement). Therefore, step 107 may be performed. When the loss of the student model to be constructed satisfies the convergence condition, it indicates that the predicted gaze information output by the student model to be constructed is matched well with the target gaze label, and the gaze prediction requirement in the inference phase is met (for example, the gaze prediction accuracy meets the requirement). Therefore, step 108 may be performed.

Step 107: Update the model parameter of the student model to be constructed based on the plurality of pieces of predicted gaze information and the corresponding target gaze labels. Here, the model parameter of the student model to be constructed may be updated by using a back-propagation algorithm, and then a student model to be constructed with an updated model parameter is reconstructed based on a next batch of eye sample images. It should be understood that the next batch of eye sample images and the current batch of eye sample images may be at least partially the same, or may be completely different.

Step 108: Determine the student model to be constructed as the gaze prediction model. For example, if it is determined, based on the plurality of pieces of predicted gaze information and the corresponding target gaze labels, that the loss of the student model to be constructed satisfies the convergence condition, the construction of the student model to be constructed may be directly ended, and the current student model to be constructed may be used as the gaze prediction model.

As a possible implementation, the label filter condition in this exemplary embodiment of the present disclosure may be limited through threshold comparison or loss sorting.

When the label filter condition in this exemplary embodiment of the present disclosure is limited through threshold comparison, the label filter condition includes: the loss determined based on the predicted gaze information and the corresponding truth gaze label is greater than a loss threshold. It should be understood that the loss threshold here may be determined empirically.

In actual applications, an eye sample image for which a loss determined based on predicted gaze information and a corresponding truth gaze label is greater than the loss threshold is determined as dirty data by determining a relationship between the loss threshold and the loss determined based on the predicted gaze information and the corresponding truth gaze label. Reference gaze information output by the constructed teacher model with relatively high gaze prediction accuracy is used as a target gaze label. A loss is re-determined based on the target gaze label and the corresponding predicted gaze information. In this way, dirty data in the eye sample images is cleaned, avoiding the impact of the dirty data on the accuracy of constructing the student model to be constructed.

When the label filter condition in this exemplary embodiment of the present disclosure is limited through loss sorting, the method provided in this exemplary embodiment of the present disclosure may further include: sorting the losses determined based on the predicted gaze information and the corresponding truth gaze labels in descending order, the label filter condition including: the loss determined based on the predicted gaze information and the corresponding truth gaze label is ranked less than or equal to M in the sorting, where the M represents an integer less than a total number of pieces of the predicted gaze information.

In actual applications, the losses corresponding to the eye sample images may be obtained by substituting the predicted gaze information and the corresponding truth gaze labels into the loss function, and losses for different eye sample images are sorted in descending order. If the loss determined based on the predicted gaze information and the corresponding truth gaze label is ranked less than or equal to M in the sorting, it indicates that the truth gaze label may not be matched with the corresponding eye sample image. Therefore, it may be considered that the loss determined based on the predicted gaze information and the corresponding truth gaze label satisfies the label filter condition, and the target gaze label of the eye sample image corresponding to the predicted gaze information is set to the corresponding reference gaze information. In this way, the impact of the dirty data on the accuracy of constructing the student model to be constructed is avoided.

M may be considered a number of sample errors in an eye sample image construction set, and may be determined by a cleaning rate of the eye sample images and a total number of the eye sample images. Here, the cleaning rate of the eye sample images can reflect an error rate of the eye sample images, and may be determined statistically, or may be customized based on an actual situation. The total number of the eye sample images may be a number of eye sample images required for updating the model parameter of the student model to be constructed once, or a number of eye sample images in one batch for the student model to be constructed.

For example, M is positively correlated with the cleaning rate of the eye sample images, and M is positively correlated with the total number of the eye sample images.

M=rate*batch_size is used as an example. When the cleaning rate of the eye sample images rate=0.01, and the total number of the eye sample images batch_size=1000, M=10. It indicates that a number of pieces of dirty data that needs to be cleaned in this batch of eye sample images is 10. In this case, predicted gaze information corresponding to the eye sample images and truth gaze labels corresponding to the predicted gaze information may be substituted into the loss function, to obtain losses corresponding to the eye sample images. Predicted gaze information corresponding to losses for different eye sample images may then be sorted in descending order of the losses. Based on the sorted predicted gaze information, target gaze labels corresponding to the first 10 pieces of predicted gaze information are updated to reference gaze information corresponding to the first 10 pieces of predicted gaze information, while target gaze labels corresponding to the remaining 990 pieces of predicted gaze information are truth gaze labels corresponding to the remaining 990 pieces of predicted gaze information. In this way, the convergence of the student model to be constructed is redetermined, with the impact of the dirty data on the accuracy of the student model to be constructed reduced.

As can be seen from the above, in this exemplary embodiment of the present disclosure, when the student model to be constructed is constructed, regardless of the label filter condition used, all the target gaze labels corresponding to the plurality of eye sample images may include truth gaze labels corresponding to different eye sample images and reference gaze information corresponding to different eye sample images. The reference gaze information may be used to clean dirty data from all the truth gaze labels corresponding to the plurality of eye sample images, to reduce the impact of the dirty data on the accuracy of constructing the student model to be constructed.

As a possible implementation, when the losses determined based on the predicted gaze information and the corresponding truth gaze labels do not satisfy the label filter condition, it is determined that the target gaze labels corresponding to the predicted gaze information further include the corresponding reference gaze information. A loss determined based on the predicted gaze information and the corresponding target gaze label includes a first loss and a second loss, and the loss of the corresponding eye sample image may be determined based on the first loss and the second loss.

In actual applications, when the loss determined based on the predicted gaze information and the corresponding truth gaze label does not satisfy the label filter condition, it indicates that there is no dirty data in the current eye sample image, and the truth gaze label corresponding to the eye sample image may be directly used to calculate the loss. However, in order to improve the prediction accuracy of the student model to be constructed, the student model to be constructed may be supervised by using both the reference gaze information output by the teacher model with relatively high accuracy and the truth gaze label. In this case, corresponding reference gaze information and a corresponding truth gaze label may be separately used as a target gaze label of predicted gaze information corresponding to the same eye sample image. A first loss is determined based on the predicted gaze information and the corresponding truth gaze label, and a second loss is determined based on the predicted gaze information and the corresponding reference gaze information. Then, a loss for the corresponding eye sample image is determined based on the first loss and the second loss. It should be understood that the loss for the corresponding eye sample image that is determined based on the first loss and the second loss may be obtained by performing weighted summation on the first loss and the second loss, or by using other methods. This is not limited herein. In some examples, a weight of the first loss is greater than that of the second loss.

In some other examples, the loss function related to the gaze prediction model in this exemplary embodiment of the present disclosure may alternatively be represented as:

$$L = α {L}_{sof𝔱} + β ( {L}_{h a r d}^{1} + {L}_{h a r d}^{2} ) .$$

In the formula, L_{soft} is a loss calculated based on reference gaze information output by the constructed teacher model at a temperature=T and predicted gaze information output by the student model to be constructed at the temperature=T.

$${L}_{h a r d}^{1}$$

includes a loss determined based on the predicted gaze information and the truth gaze label when the eye sample image is matched with the truth gaze label.

$${L}_{h a r d}^{2}$$

includes a loss determined based on the predicted gaze information and the reference gaze information when the eye sample image is not matched with the truth gaze label.

Here,

$${L}_{soft} = - {\sum }_{r}^{N} {p}_{r}^{T} log ( {q}_{r}^{T} ) ,$$

where

$${p}_{r}^{T}$$

represents reference gaze information of a softmax output of the constructed teacher model at the temperature=T on an r^{th} class;

$${q}_{r}^{T}$$

represents predicted gaze information of a softmax output of the student model to be constructed at the temperature=T on the r^{th} class; N represents the total number of the eye sample images input into the student model to be constructed; and r represents an integer greater than or equal to 1 and less than or equal to N.

$${L}_{hard}^{1} = - {\sum }_{j}^{m} {c}_{j} log ( {q}_{j}^{1} ) ,$$

where cⱼ represents a truth gaze label on a j^{th} class that does not satisfy the label filter condition; and

$${q}_{j}^{1}$$

represents predicted gaze information of a softmax output of the student model to be constructed at a temperature=1 on the j^{th} class.

$${L}_{hard}^{2} = - {\sum }_{k}^{n} {p}_{k}^{1} log ( {q}_{k}^{1} ) {q}_{k}^{1} ,$$

where

$${p}_{k}^{1}$$

represents reference gaze information of a softmax output of the constructed teacher model at the temperature=1 on a k^{th} class; and

$${q}_{k}^{1}$$

represent predicted gaze information of a softmax output of the student model to be constructed at the temperature=1 on the k^{th} class.

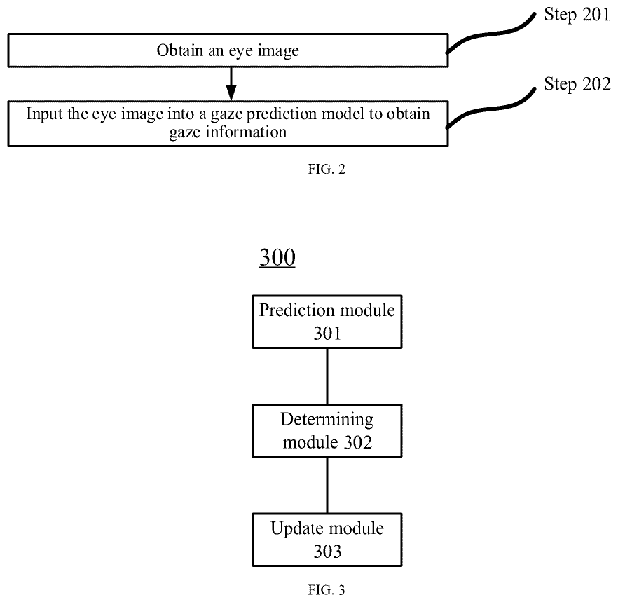

An exemplary embodiment of the present disclosure further provides a gaze prediction method for predicting a gaze direction in an eye image. FIG. 2 is a flowchart of a gaze prediction method according to an exemplary embodiment of the present disclosure. As shown in FIG. 2, the gaze prediction method includes the following steps.

Step 201: Obtain an eye image. The eye sample image is an eye sample image containing a gaze direction. It should be understood that the eye sample image here may be a picture or a video image.

In actual applications, the eye image may be acquired by an image acquisition apparatus. The image acquisition apparatus may be a camera or a video camera, and may be a standalone device, or may be a camera provided on a computing device with a display screen, or may be a camera mounted on a vehicle such as a bicycle, a motorcycle, or a car. The camera may be a monocular camera, a binocular camera, etc.

Step 202: Input the eye image into a gaze prediction model to obtain gaze information. The gaze prediction model may be constructed by using a construction method for a gaze prediction model. It should be noted here that the gaze information may be a “gaze direction” of a user acquired by the above-mentioned image acquisition apparatus. For example, when the gaze information is the “gaze direction” of the user, and the gaze prediction method is used in the field of offline retail, an interest of the user in a product on a shelf may be learned by obtaining a current “gaze direction” of the user, to implement product selection and timely adjustment of a placement position.

The solutions provided in the embodiments of the present disclosure are mainly described above. It should be understood that in order to implement the above-mentioned functions, apparatuses of the present disclosure include corresponding hardware structures and/or software modules for performing the functions. Those skilled in the art may be easily aware that units and algorithm steps of various examples described in conjunction with the embodiments disclosed herein may be implemented by hardware or a combination of hardware and computer software in the present disclosure. Whether a specific function is performed by hardware or hardware driven by computer software depends on the specific application and design constraints of the technical solution. Those skilled in the art can implement the described functions by using different methods for each particular application, but such implementation should not be considered as going beyond the scope of the present disclosure.

In the embodiments of the present disclosure, the apparatuses of the present disclosure may be divided into functional units based on the above-mentioned method examples. For example, each functional module may be obtained through division based on each corresponding function, or two or more functions may be integrated into one processing module. The above-mentioned integrated module may be implemented in the form of hardware, or may be implemented in the form of a software functional module. It should be noted that division into the modules in the embodiments of the present disclosure is illustrative and is merely logical function division, and there may be other division methods in actual implementation.

When each functional module is obtained through division based on each corresponding function, an exemplary embodiment of the present disclosure provides a construction apparatus. The construction apparatus may be an electronic device or a chip applied to the electronic device. FIG. 3 is a schematic block diagram of functional modules of a construction apparatus according to an exemplary embodiment of the present disclosure. As shown in FIG. 3, the construction apparatus 300 includes:
a prediction module 301 configured to input a plurality of eye sample images into a constructed teacher model to obtain a plurality of pieces of reference gaze information, and input the plurality of eye sample images into a student model to be constructed to obtain a plurality of pieces of predicted gaze information, where each eye sample image, each piece of reference gaze information, and each piece of predicted gaze information correspond to each other;
a determining module 302 configured to: when losses determined based on the predicted gaze information and corresponding truth gaze labels satisfy a label filter condition, determine that target gaze labels of the eye sample images are corresponding reference gaze information, or if the losses determined based on the predicted gaze information and the corresponding truth gaze labels do not satisfy the label filter condition, determine that the target gaze labels of the eye sample image are the corresponding truth gaze labels, and if it is determined, based on the plurality of pieces of predicted gaze information and corresponding target gaze labels, that a loss of the student model to be constructed satisfies a convergence condition, determine the student model to be constructed as a gaze prediction model; and
an update module 303 configured to: if it is determined, based on the plurality of pieces of predicted gaze information and the corresponding target gaze labels, that the loss of the student model to be constructed does not satisfy the convergence condition, update a model parameter of the student model to be constructed based on the plurality of pieces of predicted gaze information and the corresponding target gaze labels.

In a possible implementation, the label filter condition includes: the loss determined based on the predicted gaze information and the corresponding truth gaze label is greater than a loss threshold.

In a possible implementation, the label filter condition includes: the plurality of pieces of predicted gaze information are sorted in descending order of the losses determined based on the predicted gaze information and the corresponding target gaze labels, and the predicted gaze information is a k^{th} piece of predicted gaze information, where k is greater than 0 and less than or equal to M, and M represents an integer less than a total number of pieces of predicted gaze information.

In a possible implementation, M is positively correlated with a cleaning rate of the eye sample images, and the M is positively correlated with a total number of the eye sample images.

In a possible implementation, when the losses determined based on the predicted gaze information and the corresponding truth gaze labels do not satisfy the label filter condition, it is determined that the target gaze labels corresponding to the predicted gaze information further include the corresponding reference gaze information, where a loss determined based on the predicted gaze information and the corresponding target gaze label includes a first loss and a second loss.

In a possible implementation, the first loss is determined based on the predicted gaze information and the corresponding truth gaze label, and the second loss is determined based on the predicted gaze information and the corresponding reference gaze information.

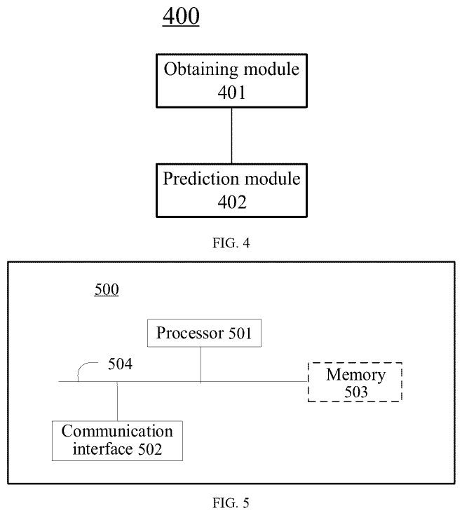

When each functional module is obtained through division based on each corresponding function, an exemplary embodiment of the present disclosure provides a gaze prediction apparatus. The gaze prediction apparatus may be an electronic device or a chip applied to the electronic device. FIG. 4 is a schematic block diagram of functional modules of a gaze prediction apparatus according to an exemplary embodiment of the present disclosure. As shown in FIG. 4, the gaze prediction apparatus 400 includes:
an obtaining module 401 configured to obtain an eye image; and
a prediction module 402 configured to input the eye image into a gaze prediction model to obtain gaze information, where the gaze prediction model is constructed by using the above-mentioned construction method for a gaze prediction model.

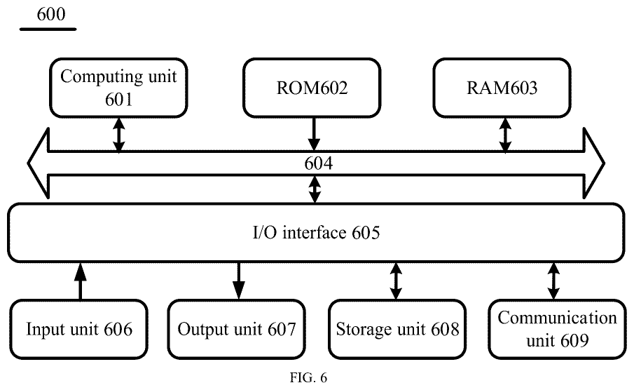

FIG. 5 is a schematic block diagram of a chip according to an exemplary embodiment of the present disclosure. As shown in FIG. 5, the chip 500 includes one or more (including two) processors 501 and a communication interface 502. The communication interface 502 may support an electronic device in performing data sending and receiving steps in the methods described above, and the processor 501 may support the electronic device in performing data processing steps in the methods described above.

Optionally, as shown in FIG. 5, the chip 500 further includes a memory 503. The memory 503 may include a read-only memory and a random access memory, and provide operation instructions and data to the processor. A part of the memory may further include a non-volatile random access memory (NVRAM).

In some implementations, as shown in FIG. 5, the processor 501 performs corresponding operations by calling the operation instructions stored in the memory (the operation instructions may be stored in an operating system). The processor 501 controls a processing operation of any one of terminal devices. The processor may also be referred to as a central processing unit (CPU). The memory 503 may include a read-only memory and a random access memory, and provide instructions and data to the processor 501. A part of the memory 503 may further include an NVRAM. For example, in an application, the memory, the communication interface, and the memory are coupled together by using a bus system. In addition to a data bus, the bus system may further include a power bus, a control bus, a status signal bus, and the like. However, for the sake of clarity, various buses are labeled as a bus system 504 in FIG. 5.

The methods disclosed in the above-mentioned embodiments of the present disclosure may be applied to the processor, or be implemented by the processor. The processor may be an integrated circuit chip with a signal processing capability. During implementation, the steps in the methods described above may be completed by using a hardware integrated logic circuit in the processor or by using instructions in the form of software. The above-mentioned processor may be a general-purpose processor, a digital signal processor (DSP), an application-specific integrated circuit (ASIC), a field programmable gate array (FPGA) or another programmable logic device, a discrete gate or transistor logic device, or a discrete hardware component. The methods, steps, and logic block diagrams disclosed in the embodiments of the present disclosure may be implemented or performed. The general-purpose processor may be a microprocessor, or the processor may be any conventional processor or the like. The steps of the methods disclosed in combination with the embodiments of the present disclosure may be directly embodied as being completed by a hardware decoding processor, or by a combination of hardware in the decoding processor and a software module. The software module may be located in a mature storage medium in the art, such as a random access memory, a flash memory, a read-only memory, a programmable read-only memory, an electrically erasable programmable memory, or a register. The storage medium is located in the memory. The processor reads information in the memory, and completes the steps in the methods described above in combination with the hardware of the processor.

An exemplary embodiment of the present disclosure further provides an electronic device. The electronic device includes: a processor; and a memory in communicative connection with the processor and storing a program, where the program includes instructions that, when executed by the processor, cause the processor to perform the methods according to the exemplary embodiments of the present disclosure.

An exemplary embodiment of the present disclosure further provides a non-transitory computer-readable storage medium storing a computer program, where computer instructions are used to cause a computer to perform the methods according to the embodiments of the present disclosure.

With reference to FIG. 6, a structural block diagram of an electronic device 600 that may serve as a server or a client in an exemplary embodiment of the present disclosure is described below. The electronic device is an example of a hardware device that may be applied to various aspects of the present disclosure. The electronic device is intended to represent various forms of digital electronic computer devices, such as a laptop computer, a desktop computer, a workbench, a personal digital assistant, a server, a blade server, a mainframe computer, and another suitable computer. The electronic device may alternatively represent various forms of mobile devices, such as personal digital processing, a cellular telephone, a smartphone, a wearable device, and another similar computing device. Components, their connections and relationships, and their functions shown herein are only examples, and are not intended to limit the implementation of the present disclosure described and/or claimed herein.

As shown in FIG. 6, the electronic device 600 includes a computing unit 601 that may perform a variety of appropriate actions and processing in accordance with a computer program stored in a read-only memory (ROM) 602 or a computer program loaded from a storage unit 606 into a random access memory (RAM) 603. The RAM 603 may further store various programs and data required for the operation of the device 600. The computing unit 601, the ROM 602, and the RAM 603 are connected to each other through a bus 604. An input/output (I/O) interface 605 is also connected to the bus 604.

A plurality of components in the electronic device 600 are connected to the I/O interface 605, including: an input unit 606, an output unit 607, the storage unit 608, and a communication unit 609. The input unit 606 may be any type of device that can input information to the electronic device 600, and the input unit 606 may receive input numeric or character information, and generate key signal inputs related to user settings and/or function control of the electronic device. The output unit 607 may be any type of device that can present information, and may include but is not limited to a display, a speaker, a video/audio output terminal, a vibrator, and/or a printer. The storage unit 604 may include but is not limited to a magnetic disk and an optical disc. The communication unit 609 allows the electronic device 600 to exchange information/data with other devices through a computer network, such as the Internet, and/or various telecommunication networks, and may include but is not limited to a modem, a network adapter, an infrared communication device, a wireless communication transceiver, and/or a chipset, such as a Bluetooth™ device, a Wi-Fi device, a WiMax device, a cellular communication device, and/or analogues.

The computing unit 601 may be various general-purpose and/or special-purpose processing components with processing and computing capabilities. Some examples of the computing unit 601 include but are not limited to a central processing unit (CPU), a graphics processing unit (GPU), various dedicated artificial intelligence (AI) computing chips, various computing units running machine learning model algorithms, a digital signal processor (DSP), and any appropriate processor, controller, microcontroller, etc. The computing unit 601 performs the various methods and processing described above. For example, in some embodiments, the methods described above may be implemented as a computer software program tangibly embodied in a machine-readable medium, such as the storage unit 608. In some embodiments, some or all of computer programs may be loaded into and/or installed onto the electronic device 600 via the ROM 602 and/or the communication unit 609. In some embodiments, the computing unit 601 may be configured to perform the methods described above in any other appropriate manner (for example, by means of firmware).

Program code used to implement the methods of the present disclosure may be written in any combination of one or more programming languages. The program code may be provided to a processor or a controller of a general-purpose computer, a special-purpose computer, or another programmable data processing apparatus, such that the program code, when executed by the processor or the controller, causes functions/operations specified in the flowcharts and/or the block diagrams to be implemented. The program code may be completely or partially executed on a machine, or may be executed as an independent software package partially on a machine and partially on a remote machine, or completely on a remote machine or a server.

In the context of the present disclosure, the machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

As used in the present disclosure, the terms “machine-readable medium” and “computer-readable medium” refer to any computer program product, device, and/or apparatus (for example, magnetic disk, optical disc, memory, programmable logic device (PLD)) that is used to provide machine instructions and/or data to a programmable processor, including a machine-readable medium that receives machine instructions serving as machine-readable signals. The term “machine-readable signal” refers to any signal that is used to provide machine instructions and/or data to a programmable processor.

To provide interaction with a user, the systems and technologies described herein may be implemented on a computer. The computer is provided with: a display apparatus (for example, a cathode ray tube (CRT) or a liquid crystal display (LCD) monitor) used to display information to a user; and a keyboard and pointing apparatus (for example, a mouse or trackball) through which the user can provide input to the computer. Other kinds of apparatuses may also be used to provide interaction with a user. For example, feedback provided to the user may be any form of sensory feedback (for example, visual feedback, auditory feedback, or tactile feedback); and input from the user may be received in any form (including sound input, voice input, or tactile input).

The systems and technologies described herein may be implemented in a computing system (for example, serving as a data server) that includes a background component, or a computing system (for example, an application server) that includes a middleware component, or a computing system that includes a front-end component (for example, a user computer having a graphical user interface or a web browser through which a user can interact with implementations of the systems and technologies described herein), or a computing system that includes any combination of such a background component, a middleware component or a front-end component. The components of the system may be interconnected through digital data communication (for example, a communication network) in any form or of any medium. Examples the communication network include: a local area network (LAN), a wide area network (WAN), and the Internet.

A computer system may include a client and a server. The client and the server are generally far away from each other and usually interact with each other through a communication network. A relationship between the client and the server is generated by computer programs running on corresponding computers and having a client-server relationship with each other.

The above-mentioned embodiments may be completely or partially implemented by software, hardware, firmware, or any combination thereof. When implemented by software, all or some of the embodiments may be implemented in the form of the computer program product. The computer program product includes one or more computer programs or instructions. When the computer programs or instructions are loaded and executed on a computer, the procedures or functions described in the embodiments of the present disclosure are completely or partially executed. The computer may be a general-purpose computer, a special-purpose computer, a computer network, a terminal, user equipment, or another programmable apparatus. The computer programs or instructions may be stored in the computer-readable storage medium, or may be transmitted from one computer-readable storage medium to another computer-readable storage medium. For example, the computer programs or instructions may be transmitted from one website, computer, server, or data center to another website, computer, server, or data center in a wired or wireless manner. The computer-readable storage medium may be any usable medium accessible by the computer, or may be a data storage device, such as a server or a data center, that integrates one or more usable media. The usable medium may be a magnetic medium, such as a floppy disk, a hard disk, and a magnetic tape, or may be an optical medium, such as a digital video disc (DVD), or may be a semiconductor medium, such as a solid-state drive (SSD).

Although the present disclosure has been described in conjunction with specific features and embodiments thereof, it will be apparent that various modifications and combinations may be made thereto without departing from the spirit and scope of the present disclosure. Correspondingly, the specification and the accompanying drawings are merely exemplary illustrations of the present disclosure as defined by the appended claims, and are regarded as covering any and all modifications, variations, combinations or equivalents within the scope of the present disclosure. Clearly, those skilled in the art may make various modifications and variations to the present disclosure without departing from the spirit and scope of the present disclosure. Therefore, if these modifications and variations of the present disclosure fall within the scope of the claims of the present disclosure and equivalent technologies thereof, the present disclosure is also intended to include these modifications and variations.

1. A construction method for a gaze prediction model, the construction method comprising:
inputting a plurality of eye sample images into a constructed teacher model to obtain a plurality of pieces of reference gaze information;
inputting the plurality of eye sample images into a student model to be constructed to obtain a plurality of pieces of predicted gaze information, wherein the eye sample images, the reference gaze information, and the predicted gaze information correspond to each other;
in response to losses determined based on the predicted gaze information and corresponding truth gaze labels satisfying a label filter condition, determining that target gaze labels of the eye sample images comprise corresponding reference gaze information, or in response to the losses determined based on the predicted gaze information and the corresponding truth gaze labels not satisfying the label filter condition, determining that the target gaze labels of the eye sample images comprise the corresponding truth gaze labels; and
if it is determined, based on the plurality of pieces of predicted gaze information and corresponding target gaze labels, that a loss of the student model to be constructed does not satisfy a convergence condition, updating a model parameter of the student model to be constructed based on the plurality of pieces of predicted gaze information and the corresponding target gaze labels, or if it is determined, based on the plurality of pieces of predicted gaze information and the corresponding target gaze labels, that the loss of the student model to be constructed satisfies the convergence condition, determining the student model to be constructed as the gaze prediction model.

2. The construction method for a gaze prediction model according to claim 1, wherein the label filter condition comprises: the loss determined based on the predicted gaze information and the corresponding truth gaze label is greater than a loss threshold.

3. The construction method for a gaze prediction model according to claim 1, wherein the construction method further comprises: sorting the losses determined based on the predicted gaze information and the corresponding truth gaze labels in descending order, and wherein the label filter condition comprises: the loss determined based on the predicted gaze information and the corresponding truth gaze label is ranked less than or equal to M in the sorting, wherein M represents an integer less than a total number of pieces of predicted gaze information.

4. The construction method for a gaze prediction model according to claim 3, wherein M is positively correlated with a cleaning rate of the eye sample images, and M is positively correlated with a total number of the eye sample images.

5. The construction method for a gaze prediction model according to claim 1, wherein the construction method further comprises:
in response to the losses determined based on the predicted gaze information and the corresponding truth gaze labels not satisfying the label filter condition, determining that the target gaze labels corresponding to the predicted gaze information further comprise the corresponding reference gaze information, wherein a loss determined based on the predicted gaze information and the corresponding target gaze label comprises a first loss and a second loss, the first loss is determined based on the predicted gaze information and the corresponding truth gaze label, and the second loss is determined based on the predicted gaze information and the corresponding reference gaze information.

6. The construction method for a gaze prediction model according to claim 5, wherein a weight of the first loss is greater than that of the second loss.

7. A gaze prediction method, comprising:
obtaining an eye image; and
inputting the eye image into a gaze prediction model to obtain gaze information, wherein the gaze prediction model is constructed by the construction method for a gaze prediction model according to claim 1.

8. (canceled)

9. (canceled)

10. An electronic device, comprising:
a processor; and
a memory in communicative connection with the processor and storing a program,
wherein the program comprises instructions that, when executed by the processor, cause the processor to perform the following construction operations for a gaze prediction model:
inputting a plurality of eye sample images into a constructed teacher model to obtain a plurality of pieces of reference gaze information;
inputting the plurality of eye sample images into a student model to be constructed to obtain a plurality of pieces of predicted gaze information, wherein the eye sample images, the reference gaze information, and the predicted gaze information correspond to each other;
in response to losses determined based on the predicted gaze information and corresponding truth gaze labels satisfying a label filter condition, determining that target gaze labels of the eye sample images comprise corresponding reference gaze information, or in response to the losses determined based on the predicted gaze information and the corresponding truth gaze labels not satisfying the label filter condition, determining that the target gaze labels of the eye sample images comprise the corresponding truth gaze labels; and
if it is determined, based on the plurality of pieces of predicted gaze information and corresponding target gaze labels, that a loss of the student model to be constructed does not satisfy a convergence condition, updating a model parameter of the student model to be constructed based on the plurality of pieces of predicted gaze information and the corresponding target gaze labels, or if it is determined, based on the plurality of pieces of predicted gaze information and the corresponding target gaze labels, that the loss of the student model to be constructed satisfies the convergence condition, determining the student model to be constructed as the gaze prediction model.

11. A non-transitory computer-readable storage medium storing computer instructions, wherein the computer instructions are used to cause a computer to perform the following construction operations for a gaze prediction model:
inputting a plurality of eye sample images into a constructed teacher model to obtain a plurality of pieces of reference gaze information;
inputting the plurality of eye sample images into a student model to be constructed to obtain a plurality of pieces of predicted gaze information, wherein the eye sample images, the reference gaze information, and the predicted gaze information correspond to each other;
in response to losses determined based on the predicted gaze information and corresponding truth gaze labels satisfying a label filter condition, determining that target gaze labels of the eye sample images comprise corresponding reference gaze information, or in response to the losses determined based on the predicted gaze information and the corresponding truth gaze labels not satisfying the label filter condition, determining that the target gaze labels of the eye sample images comprise the corresponding truth gaze labels; and
if it is determined, based on the plurality of pieces of predicted gaze information and corresponding target gaze labels, that a loss of the student model to be constructed does not satisfy a convergence condition, updating a model parameter of the student model to be constructed based on the plurality of pieces of predicted gaze information and the corresponding target gaze labels, or if it is determined, based on the plurality of pieces of predicted gaze information and the corresponding target gaze labels, that the loss of the student model to be constructed satisfies the convergence condition, determining the student model to be constructed as the gaze prediction model.

12. (canceled)

13. (canceled)

14. The electronic device according to claim 10, wherein the label filter condition comprises: the loss determined based on the predicted gaze information and the corresponding truth gaze label is greater than a loss threshold.

15. The electronic device according to claim 10, wherein the instructions, when executed by the processor, cause the processor to further perform the following operation: sorting the losses determined based on the predicted gaze information and the corresponding truth gaze labels in descending order, and wherein the label filter condition comprises: the loss determined based on the predicted gaze information and the corresponding truth gaze label is ranked less than or equal to M in the sorting, wherein M represents an integer less than a total number of pieces of predicted gaze information.

16. The electronic device according to claim 15, wherein M is positively correlated with a cleaning rate of the eye sample images, and M is positively correlated with a total number of the eye sample images.

17. The electronic device according to claim 10, wherein the instructions, when executed by the processor, cause the processor to further perform the following operation:
in response to the losses determined based on the predicted gaze information and the corresponding truth gaze labels not satisfying the label filter condition, determining that the target gaze labels corresponding to the predicted gaze information further comprise the corresponding reference gaze information, wherein a loss determined based on the predicted gaze information and the corresponding target gaze label comprises a first loss and a second loss, the first loss is determined based on the predicted gaze information and the corresponding truth gaze label, and the second loss is determined based on the predicted gaze information and the corresponding reference gaze information.

18. The electronic device according to claim 17, wherein a weight of the first loss is greater than that of the second loss.

19. An electronic device, comprising:
a processor; and
a memory in communicative connection with the processor and storing a program,
wherein the program comprises instructions that, when executed by the processor, cause the processor to perform the method according to claim 7.

20. The storage medium according to claim 11, wherein the label filter condition comprises: the loss determined based on the predicted gaze information and the corresponding truth gaze label is greater than a loss threshold.

21. The storage medium according to claim 11, wherein the computer instructions are used to cause the computer to further perform the following operation: sorting the losses determined based on the predicted gaze information and the corresponding truth gaze labels in descending order, and wherein the label filter condition comprises: the loss determined based on the predicted gaze information and the corresponding truth gaze label is ranked less than or equal to M in the sorting, wherein M represents an integer less than a total number of pieces of predicted gaze information.

22. The storage medium according to claim 21, wherein M is positively correlated with a cleaning rate of the eye sample images, and M is positively correlated with a total number of the eye sample images.

23. The storage medium according to claim 11, wherein the computer instructions are used to cause the computer to further perform the following operation:
in response to the losses determined based on the predicted gaze information and the corresponding truth gaze labels not satisfying the label filter condition, determining that the target gaze labels corresponding to the predicted gaze information further comprise the corresponding reference gaze information, wherein a loss determined based on the predicted gaze information and the corresponding target gaze label comprises a first loss and a second loss, the first loss is determined based on the predicted gaze information and the corresponding truth gaze label, and the second loss is determined based on the predicted gaze information and the corresponding reference gaze information.

24. The storage medium according to claim 23, wherein a weight of the first loss is greater than that of the second loss.
